(19) United States
(12) Patent Application Publication
(10) Pub. No.: US 2020/0188879 A1
(43) Pub. Date: Jun. 18, 2020

(54) COMPOSITE PARTICLES WITH IMPERMEABLE PARTICLES AND WATER-ABSORBING POLYMER COATINGS

(71) Applicant: PALO ALTO RESEARCH CENTER INCORPORATED, Palo Alto, CA (US)

(72) Inventors: GABRIEL IFTIME, NEWARK, CA (US); DIVYARAJ DESAI, FREMONT, CA (US); JESSICA LOUIS BAKER RIVEST, PALO ALTO, CA (US)

(21) Appl. No.: 16/704,299

(22) Filed: Dec. 5, 2019

Related U.S. Application Data
(60) Provisional application No. 62/778,343, filed on Dec. 12, 2018.

(51) Int. Cl. B01J 20/28; B01J 20/26; B01J 20/32; E04B 2/00

(52) U.S. Cl. CPC B01J 20/28021; B01J 20/261; B01J 20/262; B01J 20/264; E04C 2/46; B01J 20/3293; B01J 20/3231; B01J 20/3223; B01J 20/267

(57) ABSTRACT

A composite particle includes a solid particle, and a coating directly on the solid particle, the coating comprising a water-absorbing material. A layer includes a plurality of composite particles in contact, wherein the composite particles are comprised of: a solid particle; and a coating directly on the solid particle, the coating comprising a water-absorbing material. A method of fabricating composite particles includes combining solid particles with at least one precursor, cross-linker, and radical initiator in a solution to cause polymerization and formation of a water-absorbing coating on the solid particles resulting in composite particles, removing the solution and any unreacted precursors, and drying the composite particles. A method of forming composite particles includes mixing solid particles with at least one adhesive and with premade water-absorbing super absorbent polymer particles, curing the adhesive to form a monolithic block of solid particles with water-absorbing polymer coatings, and grinding the block to obtain composite particles.

### CROSS REFERENCE TO RELATED APPLICATION

This application claims priority to and the benefit of U.S. Provisional Application No. 62/778,343 filed Dec. 12, 2018, which is incorporated herein by reference in its entirety.

### TECHNICAL FIELD

This disclosure relates to composite particles, more particularly to composite particles having a coating of a super absorbent polymer.

### BACKGROUND

Water-absorbing materials have the capability of absorbing aqueous solutions. Water absorption generally results in swelling of the water-absorbing material. Typically water-absorbing are polymers that absorb water through hydrogen bonding with water molecules. A water-absorbing material can absorb at least an amount of water that is 50% of the polymer volume, to increase the volume of the water absorbing material to at least 1.5× of their volume in dry state. Super absorbent polymers (SAP) materials represent a particular class of water-absorbing materials that have the unique property of absorbing large amounts of water (up to 1000× their volume). They have found use in a variety of applications including fire retardants, sealing cracks in cement, flood control, water retention and moisture control in soils, waste solidification, blocking water penetration in underground power or communications cable. They are generally useful in any application requiring water retention and/or controlled water release.

Water-absorbing polymers such as superabsorbent polymers today are either powders or beads made of a special type of polymer that can absorb large amounts of water. They provide an easy solution in situations where there is a need to either stop water penetration, such as concrete, cement cracks. They are also used in agricultural applications to reduce the irrigation requirements by absorbing water that otherwise will drain quickly. Other situations may be envisioned. These materials must be mechanically and structurally robust for long times, typically years and must be able to sustain many wet/dry cycles with minimal performance loss over time.

Today, water-absorbing polymers such as the SAP polymer powders or beads are generally mixed into a material of interest such as soils, for example. Such structures lack mechanical strength and overall material integrity. Powders or beads of water-absorbing material separate away from the material they need to protect and they can be relatively easily dissolved in water to leach out of the structure they are incorporated into.

A need exists for robust, maintenance-free water-absorbing material structures that maintain their mechanical integrity and the expected performance for longer durations without separating away from the materials into which they are mixed.

### BRIEF DESCRIPTION OF THE DRAWINGS

FIG. 1 shows a diagram of a composite particle.

FIGS. 2-3 shows embodiments of a composite particle.

FIG. 4-5 shows diagrams of embodiments of reversible sealing with impermeable particles.

FIG. 6 shows a proposed sustainable cover and vegetation layer.

FIG. 7 shows an embodiment of a reinforced composite particle cover structure.

FIG. 8 shows an embodiment of a water/capture release mechanism using a composite particle.

FIG. 9 shows an example of sand.

FIGS. 10 and 11 shows embodiments of composite particles that demonstrate composite particle characteristics.

### DETAILED DESCRIPTION OF THE EMBODIMENTS

Embodiments described here involve composite particles consisting of an inner solid particle coated with a shell of a water-absorbing polymer material. The novel composite particle has the ability to absorb/release water reversibly without separation of the water-absorbing polymer from the core particle material. An object consisting of a multitude of such particles can become self-sealing by substantially decreasing or eliminating further water. In a particular embodiment, the object can be a layer, also referred to as a cover layer, consisting of a multitude of such particles can form a seal to substantially decrease or eliminate further water penetration into structures onto which they are deposited or over which they are laid as a cover. The layer decreases the water permeation rate by at least of a factor of 1.5× when compared with a layer made of the same solid particle but without the water absorbing coating. In many situations the layer can reduce the water permeation rate by orders of magnitude such as 10× or 100× or even 1000×.

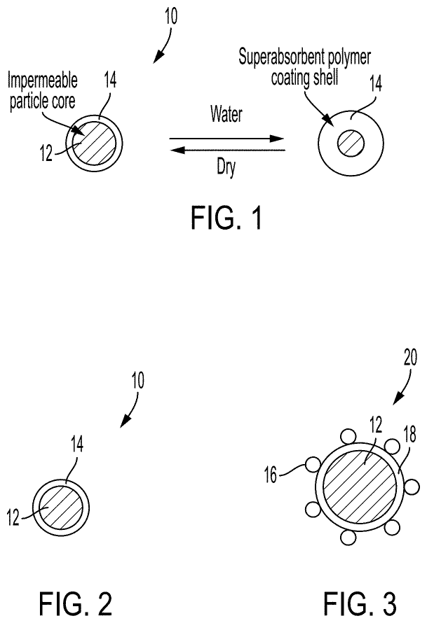

FIG. 1 shows an embodiment of a composite particle 10 comprising a solid particle core 12 with a superabsorbent polymer coating 14. The solid particle may be fully- or partially-impermeable to water. Suitable examples include, without limitation: sand, quartz, fly ashes, lignin, silica, glass, soil components, grinded cement particles, and other inorganic construction materials that are generally extracted from the ground or underground.

A particular type of suitable solid particles is represented by plate-like particles, which are known to generally decrease permeation rates of gases by the creation of a tortuous diffusion path for the penetrating gases (Y. Cui et al. Carbon, 98, (2016), 313-333). Plate-like shaped solid particles coated with water absorbing polymers are expected to possess extremely good barrier properties against water permeation due to combining of the both plate-shaped particles effect and water swelling of the coating. Plate-shaped particles are beneficial because their use may allow for either a decrease in the amount of coating onto solid particles or allow for lower performing and potentially lower cost, water-absorbing polymers while maintaining the overall water sealing performance of the particle or of the objects and cover layers made with these particles. Examples of suitable plate-shaped solid particles include clays, kaolin, plate-shaped aluminum oxide particles, graphene, hydroxyapatite and the like. These particles are generally up to a couple of microns in size in the XY plane. Larger plate shaped particles like gravel and rocks are also beneficial for enhancing the water-barrier properties of layers when compared with irregularly shaped particles.

Other suitable solid particles include hydrophobic organic polymer particles. Many organic polymer materials are fully or at least partially impermeable to water. Hydrophobic organic polymer solid particles may be advantageous for producing lightweight structures within these particles since their density is generally lower than that of inorganic particles. Examples of generally known impermeable organic polymers suitable as solid particles include polyethylene, polystyrene, polyamides, polyacrylates, polyethers, polyolefins, polyesters, polycarbonates, epoxy resins including both two part epoxy where the epoxy resin is mixed with a reactive hardener, as well as all-in-one epoxy resins where the epoxy resin is mixed with a latent curing initiator that is stable when handled in ambient conditions but cures when exposed to either heat or in other cases by ultraviolet light (UV). Mixtures of these polymers or copolymers incorporating the monomers used to produce these polymers are also suitable.

Typical fabrication methods for organic solid particles include: (as) direct polymerization of monomers such as vinyl and acrylate monomers. Different particle sizes can be achieved by different polymerization techniques: up to 200 nm particles can be obtained by emulsion polymerization including mini-emulsion and particles of microns size can be achieved by dispersion polymerization; phase inversion emulsification in water with surfactants; homogenization of polymer solution in solvents in the presence of water and surfactants. Many of these polymer particles are commercially available for example at Sigma-Aldrich.

The size of the particles may range from 0.1 micron (micrometer) to 10 meters. In specific applications, particle size may range from millimeters to centimeters. The particle may have any shape including but not limited to: irregular; spherical; cylindrical; and other shapes. Examples of water-absorbing polymer materials include, without limitation: poly-acrylic acid sodium salt, also referred to as sodium polyacrylate; cross-linked polyacrylamide copolymers; ethylene maleic anhydride copolymers; cross-linked polyethyleneglycols; polyvinyl alcohol co-polymers; cross-linked carboxylmethylcellulose; starch grafted copolymer of polyacrylonitrile; water-soluble epoxy resins such as commercially available Durcupan® that cures with a base initiator such as Ca(OH)₂, NaOH or other suitable base; poly(ethylene-co-vinyl alcohol) (EVAL); poly(ethylene-co-vinyl acetate) (EVAc); and water soluble polyurethanes, generally fabricated by polycondensation of polyisocyanates with polyethylene glycols

Adhesives used may include any adhesive compatible with the particle core that maintains its adhesive properties in the presence of water. Suitable examples include, without limitation: epoxies, such as two-part epoxies, especially those for waterproof applications; silicone adhesives; and acrylic adhesives that can be one or two-part formulations; and other adhesives.

As shown in FIG. 1, the composite particle 10 swells in the presence of water. Since the particle core is impermeable to water, it is actually the water-absorbing polymer coating 14 that absorbs water. This process is reversible and as the environment dries out, the coating loses the water it had retained.

FIGS. 2 and 3 show possible embodiments for composite particles. In FIG. 2, the composite particle 10 has a water absorbing polymer coating comprising a continuous layer 14 directly on the surface of the solid particle core 12. In FIG. 3, the composite particle 20 comprises a solid particle core 12 having a layer or coating of SAP particles such as 16 bonded onto the surface of the particle core 12 with the aid of an adhesive 18 as part of the coating. Generally, the water-absorbing polymer particles will be smaller than the particle core.

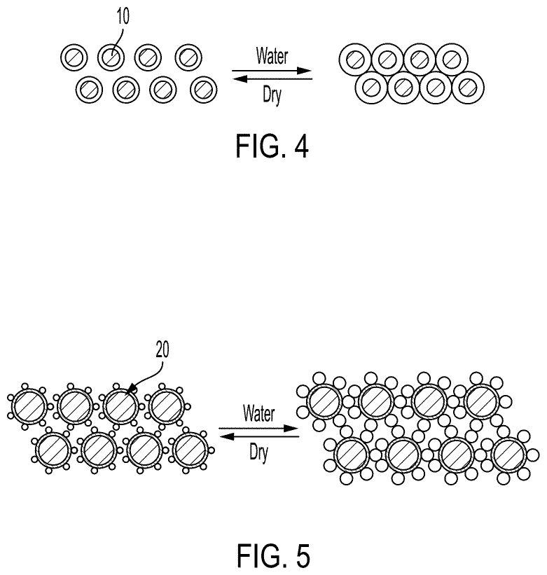

However they are formed, the composite particles form a sealing layer that prevents further water penetration into those structures they are intended to protect. FIG. 4 shows an example of a composite particle such as 10 with a continuous coating forming a sealing layer. FIG. 5 shows an embodiment of composite particles having water-absorbing polymer particles bonded onto the adhesive layer. When the water-absorbing polymer particles swell in the presence of water, they form a sealing layer as shown on the right side of the diagram.

When compared with current water-absorbing polymer powders and beads, the embodiments of composite particles having solid particles coated with a water-absorbing polymer layer are stronger mechanically because of the inner, strong, solid particle. Also, the particles have increased lifetime because of the polymer attachment onto the surface of the solid particles. This prevents the water-absorbing polymer from separating away from the particle core, and therefore prevents the water-absorbing polymer from separating from the structure they protect.

The particle fabrication process may take many forms. For example, the embodiments of a continuous water-absorbing polymer layer on the surface of the particle core involves polymerization of the required precursors directly onto the surface of the solid particles. One preferred type of polymerization process suitable for fabrication of the proposed composite particles is radical polymerization. Precursors include: vinyl monomers such acrylic acid blended with sodium hydroxide or potassium hydroxide: acrylamide; cross-linkers such as poly(ethylene glycol) diacrylate, methylene bis-acrylamide (MBA), polytri, tetra, penta or hexa-acrylates and methacrylates such as trimethylolpropane triacrylate, trimethylolpropane ethoxylate triacrylate, di(trimethylolpropane) tetraacrylate, dipentaerythritol penta-/hexa-acrylate tetraallylethoxy ethane, 1,1,1-Trimethylolpropanetricrylate (TMPTA); radical initiators for thermal initiation such as potassium persulfate (K₂S₂O₈); sodium persulfate (Na₂S₂O₈); benzoyl peroxide; and azoisobutylnitrile (AIBN) etc.

As an example, sand solid particles coated with sodium polyacrylate can be fabricated by combining the various elements. In one embodiment the combining comprises mixing sand particles with monomers, cross-linker and radical initiators in a water solution. The radical initiators and cross-linkers cause the polymerization process to form polymers directly on the surface of the polymer. This is followed by removal of the water and possible unreacted monomers by filtration, followed by particle drying. The same process can be for example performed with acrylamide and crosslinkers. In some cases, UV initiation instead of thermal initiation may be performed. In this case UV initiators are used instead of thermal initiators. Depending on the monomers and crosslinkers, in some cases, their solubility in the reaction solvent can be increased by combining water with water miscible organic solvents such as methyl, ethyl 2-propyl or butanol, acetone, acetonitrile, diethylene glycol, dimethyl formamide and the like. Depending on the monomers, other processes may be suitable for fabrication of composite particles, including for example condensation polymerization or transition metal catalyzed polymerization.

A second approach for a continuous water-absorbing polymer layer consists of combining the precursors in the presence of impermeable particles. In one embodiment, this comprises polymerizing polymer precursors in the presence of high-loadings of solid particles without any mixing. In the case of sand as solid particle, the result of the polymerization and drying is a monolithic block consisting of sand with cured polymer filling in the regions between sand particles and onto the surface of the sand. Composite sand particles are produced by grinding the monolithic block.

Composite particles having the smaller-sized water-absorbing polymer particles on the surface of the solid particle, and with adhesives can be made by a simple process comprising mixing solid particles such as sand with adhesive materials and with small size water-absorbing polymer particles already cured or premade smaller particles. This provides just one example, with no intention of limitation. After curing the adhesive, the composite particles are obtained by grinding the monolithic block that results from the adhesive and particle mixing process.

The composite materials are useful for a wide range of applications related to reversible solid powder or particulate sealants with high mechanical robustness and enhanced lifetime. The discussion now turns to various applications, merely for ease of understanding, with no intention of limitation.

The particles can form high capacity self-healing concrete walls. Concrete walls containing solid particles coated with water-absorbing polymer such as sand/water-absorbing polymer where the water-absorbing polymer materials is fixed onto the surface of the sand will have long lifetime, being able to seal cracks in the walls for the duration of the structure. Current approaches uses SAP powder and beads or particles in the mixture. They generally leach out in time and therefore their efficiency is limited to a period much shorter than the lifetime of the concrete construction. This is applicable to either concrete wall and/or foundations.

The particles can be used in fabrication of fire retardant walls or concrete by incorporation of wet composite particles in the structure of the wall. Today SAP flowing gels are being used protect structures from fire by spraying them over walls after a fire is started. The fire slowing process is enabled by the high specific heat of water which takes away a large part of the heat energy by evaporation, keeping the temperature low, therefore slowing the fire access inside the structure. This approach cannot be applied with any fast expanding fire and it puts firefighters and personnel at risk.

Walls made with the composite particle from the embodiments here, for example with sand particles would protect the structure at all times and will activate fire-retarding process as soon as they are exposed to the heat. This gives more time to the firefighters to stop the fire and to residents to leave buildings.

The composite particles can form high efficiency sand bags for protecting structures from flooding. Today regular sand bags are being used to surround houses in preparation for flooding. This approach has some efficiency but is limited. It can protect the house from fast running waters but once the water settles in, it eventually penetrates through sand bags because of the space between the sand particles. Bags can be filled with randomly dispersed SAP powders and be more efficient than sand alone. They absorb water at the beginning of the flooding, but they cannot protect long term because randomly dispersed beads cannot form a good seal. Bags filled with sand as part of the composite particles will prevent water access even if water is sitting for many days because they form a very good seal that does not allow the water permeation through the sand bags wall. If one tried to use regular SAP polymer powder or beads, the seal would be imperfect because it would be difficult to fill all the pores in between sand particles with SAP material. In addition, the SAP material would leach out of the bags, therefore decreasing the sealing ability.

Sand/water-absorbing polymer composite particles are an ideal material for enhancing the water retention in all soils, particularly in sandy soils with little or no maintenance. This is because with the composite particle structure, the water-absorbing polymer attachment onto the surface of the s prevents free water-absorbing polymer from separating away from the particle, as it happens with current water-absorbing polymer such as with SAP powder or beads materials.

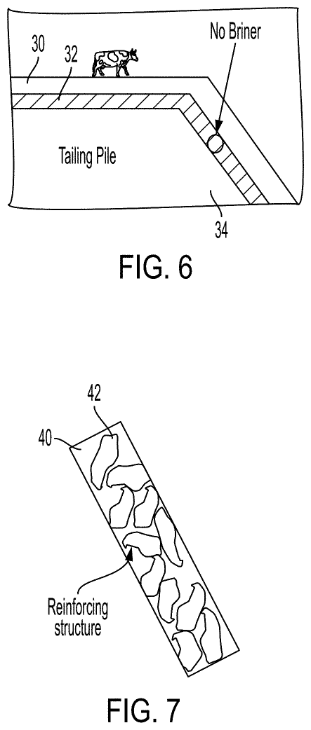

One particular embodiment uses a thin layer of cover material that virtually eliminates the brine run-off from potash waste tailing piles. The embodiments are suited for use together with a vegetation layer to provide a sustainable and maintenance free solution to the brine problem. As shown in FIG. 6, the thin layer of cover material 32 covers the tailing pile 34 to block the brine run-off. The vegetation layer 30 then covers the layer of composite particles. This layer of cover material may be referred to as NoBriner.

Alternatively, the technology can be incorporated as part of the technical approaches currently developed for maximized performance. The cover can be applied onto tailing piles with equipment that is already available at the pile sites, such as conveyor belts, excavators, and other dirt moving equipment.

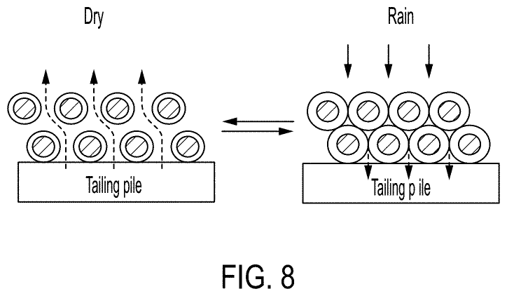

The composite particle cover layer 40 as shown in FIG. 7, consists of particles that reversibly absorb and release water when switching from wet to dry environments, reinforced with stable, heavy materials such as rocks 42 to keep the structure in place in all weather conditions, such as during rain and high winds. FIG. 8 shows a reversible water/capture and release mechanism with the layer of cover particles. During dry spells, the cover layer allows the water to evaporate through the gaps between the particles. During wet spells, the water-absorbing polymer layer swells up with water and traps it in the particles to prevent it from reaching the tailings pile.

This is particularly critical for slopes. It eliminates the brine run-off by the following mechanisms. In the presence of rain, particles capture most of the water, swell and seal the pores from between particles to prevent the remaining water from reaching the salt in the potash tailings.

In dry conditions, the structure is porous and promote efficient water evaporation from the salt pile.

The cover layer is reconfigurable, meaning it changes shape to follow the movement of the pile and self-seals preventing water penetration through holes in the salt pile

The cover layer releases the captured water directly to the vegetation cover under suction pressure by plant roots. This has several advantages: increasing evapotranspiration directly through plants; strong vegetation increases the strength of the cover; and enables sustainable use of the land, for example for agricultural needs.

The expected performance of this type of cover layer includes reducing the saline wastewater created by rainfall by more than 99.1% when compared with uncovered tailing piles. The cover layer requires no maintenance, has excellent weather-ability, and is highly resistant to wet/dry and freeze/thaw cycles. The cover layer is conformable to follow the movements of the piles, having a viscoplastic characteristic and is compatible with slopes. In other words, the cover layer is reconfigurable, because it rearranges upon the movement of the structures or piles onto which it is placed, and the cover absorbs water upon raining to form a new seal onto the new shape of the structure or piles that are being protected by the cover layer. In the same way, any structure or object made out of the multitude of composite particles form this invention are also reconfigurable, in the sense that they can be remodeled into new objects that will keep their new shape after exposure to water, both immediately or even after drying. Reinforcement makes the cover layer robust against wind, rain, and sliding. The cover layer is resistant to the corrosion layer and the abrasion from salt. The layer is low-cost, being only slightly higher than the cost of common sands or coal waste materials, sustainable because it uses widely available sand or coal waste materials, and is environmentally friendly, using non-toxic and non-corrosive materials.

In one experiment, a comparison was made of the flow rate of water through a long tube with a fritted sleeve in the following settings: no layer cover; regular sand; and a preliminary version of the cover layer material. The experiment was carried out under a continuous flow of water. The flow rate through the cover layer material was determined to be 110 times slower than in the case of no layer, sand alone decreased the flow by only a factor of 8. Estimates indicate that the cover layer alone would reduce the brine run-off by 99.1% when compared to uncovered tailing piles, far exceeding the original target of 80%. One should note that the test is accelerated by orders of magnitude, such as approximately 70,000 times faster than the precipitation rate in Frankfurt, Germany. Also, the experiment did not take into account the dry days that would allow for water evaporation in between rain episodes, nor does it take advantage of the evapotranspiration enabled by vegetation. Expectations are that in reality the brine run-off would be virtually reduced to zero.

The cover must be stable in all weather conditions, a critical requirement for slopes. As mentioned earlier, high mechanical robustness of is enabled by rocks networks. For stability, the reversibly water absorbing particles must keep their structural integrity as well, meaning they should not flow or disintegrate in rain, dry weather or in high winds.

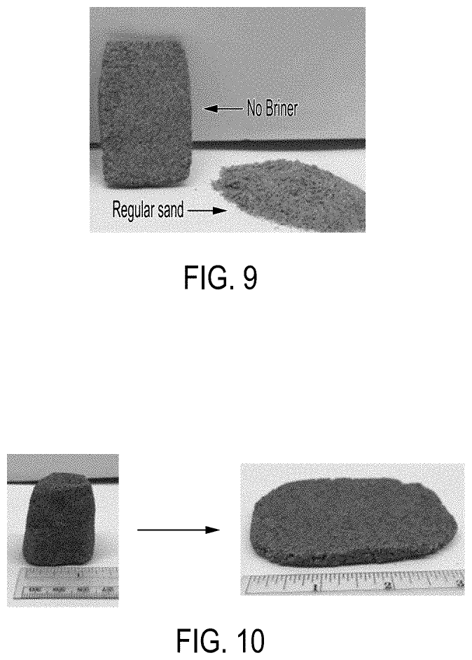

Comparative experiments were performed between a sand version of the cover layer, shown in FIG. 9, composite particles using sand as their core particle, and a hypothetical regular sand cover in wet and dry states. Both regular sand and composite particle sand maintained shape when wet. However, after being allowed to dry, the composite particle sand shown in FIG. 10, kept its structure and was relatively difficult to break, while the regular sand sample become just a pile of sand as shown in FIG. 9. This indicates that the proposed material will have adequate mechanical robustness when used with reinforcing rocks.

FIG. 10 also demonstrates the viscoplastic behavior of the wet material. The material deforms and keeps its shape when wet. This is an important enabler for the ability of the cover to following the movement of the tailing pile in the wet state.

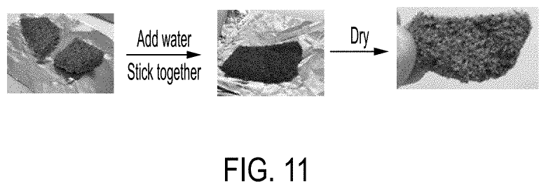

FIG. 11 demonstrates the ability of the proposed material to self-heal after a crack or movement relative to the tailing takes place, when activated by rain. On the far left picture, the dry composite material is broken into two pieces. In the center picture, the two pieces are joined together and have water poured over them. As can be seen in the far right picture, after drying the two pieces have become one piece again. The ability of the composite particle sand to reconfigure itself provides a distinct feature of the cover layer that cannot be achieved with either plastic or rigid layers such as concrete. The ability to seal cracks in the tailing structure is also unique to these embodiments.

The above discussion is one example of a use of this material and no limitation to any particular part of the embodiment is intended, nor should it be implied.

The advantages of these embodiments include that they have higher mechanical strength than conventional water-absorbing polymer powder or beads. They have an increased lifetime than conventional water-absorbing polymer powder and beads. The water-absorbing polymer composite particles have high effective sealing capabilities over the conventional water-absorbing polymer powder or beads.

The uniqueness of these embodiments include, but are not limited to particles that have the ability to absorb/release water reversibly without separation of the water-absorbing polymer material from the core particle material. A layer, also referred to as a cover layer, of a multitude of these particles can reversibly seal to substantially decrease or eliminate further water penetration into structures onto which they are deposited.

In this manner, composite particles having a superabsorbent polymer layer surrounding an impermeable core particle are provided. These particles can form a layer that moves, reconfigures and blocks almost all, if not all, of water in run-off streams. It can be used to seal cracks or other fissures in structure to prevent leakage.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the discussed embodiments.

What is claimed is:

1. A composite particle, comprising:
a solid particle; and
a coating directly on the solid particle, the coating comprising a water-absorbing material.

2. The composite particles as claimed in claim 1, wherein the water-absorbing material is capable of absorbing at least 1.5 times a volume of the coating.

3. The composite particle as claimed in claim 1, wherein the solid particle is selected from the group consisting of: sand; quartz; fly ashes; lignin; silica; glass; minerals; carbon; soil components; cement particles; and inorganic construction materials.

4. The composite particle as claimed in claim 1, wherein the solid particle comprises a hydrophobic organic polymer.

5. The composite particle as claimed in claim 1, wherein the solid particle comprises a material selected from the group consisting of: polyethylene; polystyrene; polyamides; polyacrylates; polyethers; polyolefins; polyesters; polycarbonates; two-part epoxy resins having epoxy resin mixed with a reactive hardener; all-in-one epoxy resins that are curable by one of either heat or ultraviolet light; copolymers incorporating monomers used to produce any of the group; and mixtures thereof.

6. The composite particle as claimed in claim 1, wherein the solid particle is selected from the group consisting of: plate-shaped solid particles: clays; kaolin; plate-shaped aluminum oxide particles; graphene; and hydroxyapatite.

7. The composite particle as claimed in claim 1, wherein the water-absorbing material is a polymer selected from the group consisting of: sodium polyacrylate; cross-linked polyacrylamide copolymers; ethylene maleic anhydride copolymers; cross-linked polyethyleneglycols; polyvinyl alcohol co-polymers; cross-linked carboxylmethylcellulose starch grafted copolymer of polyacrylonitrile; water-soluble epoxy resins; poly(ethylene-co-vinyl alcohol) (EVAL); poly(ethylene-co-vinyl acetate) (EVAc); and water soluble polyurethanes.

8. The composite particle as claimed in claim 1, wherein the coating comprises a layer bonded directly onto a surface of the solid particle.

9. The composite particle as claimed in claim 1, wherein the coating includes an adhesive to attach the water-absorbing material to the solid particle.

10. The composite particle as claimed in claim 9, wherein the adhesive is selected from the group comprising: one-part epoxies; two-part epoxies; silicone adhesives; one-part acrylic adhesives; and two-part acrylic adhesives.

11. The composite particle as claimed in claim 1, wherein the coating comprises a layer of water-absorbing polymer particles bonded to the solid particle by the adhesive.

12. An object, comprising:
a plurality of composite particles in contact, wherein the composite particles are comprised of:
a solid particle; and
a coating directly on the solid particle, the coating comprising a water-absorbing material.

13. The object as claimed in claim 12, wherein the object is reconfigurable.

14. The object as claimed in claim 12 wherein the object comprises a layer.

15. The object as claimed in claim 14, wherein the layer comprises a cover layer.

16. The object as claimed in claim 14, wherein the layer is configured to self-heals cracks that occur in the layer when the particles contact water.

17. The object as claimed in claim 14, further comprising one of either a fire-retardant wall, or a self-healing concrete wall.

18. The object as claimed in claim 14 where the layer is configured to be conformable.

19. The object as claimed in claim 14 where the layer decreases the water permeation rate by at least a factor of 1.5× when compared with a layer made of the same solid particle but without the water absorbing coating.

20. The object as claimed in claim 14 further incorporating reinforcing uncoated heavy rocks.

21. The object as claimed in claim 20, wherein the layer is stable in the presence of at least one of rain and wind.

22. A method of fabricating composite particles, comprising:
combining solid particles with at least one precursor, cross-linker, and radical initiator in a solution to cause polymerization and formation of a water-absorbing coating on the solid particles resulting in composite particles;
removing the solution and any unreacted precursors; and
drying the composite particles.

23. The method as claimed in claim 22, wherein the at least one precursor comprises one of vinyl monomers, acrylic acid blended with sodium hydroxide, and acrylamide.

24. The method as claimed in claim 22, wherein the cross-linkers comprise one of poly(ethylene glycol) diacrylate, methylene bis-acrylamide (MBA), tetraallylethoxy ethane, and 1,1,1-Trimethylolpropanetricrylate (TMPTA).

25. The method as claimed in claim 22, wherein the radical initiator comprises one of a thermal initiator or an ultraviolet initiator.

26. The method as claimed in claim 25, wherein the thermal initiator comprises one of potassium persulfate (K₂S₂O₈), sodium persulfate (Na₂S₂O₈), benzoyl peroxide or AIBN.

27. The method as claimed in claim 22, wherein combining comprises polymerizing precursors in the presence of the solid particles without any mixing, and removing the solution and drying the particles comprises forming a monolithic block of the composite particles, and then grinding the block to obtain the particles.

28. The method as claimed in claim 22, wherein the solid particles are selected from a group consisting of: sand; quartz; fly ashes; lignin; silica; glass; minerals; carbon; soil components; cement particles; inorganic construction materials; hydrophobic organic polymers; and plate-shaped solid particles.

29. A method of forming composite particles, comprising:
mixing solid particles with at least one adhesive and premade water-absorbing polymer particles;
curing the adhesive to form a monolithic block of solid particles with water-absorbing polymer coatings; and
grinding the block to obtain composite particles.

30. The method as claimed in claim 29, wherein the premade water-absorbing polymer particles comprise cured water-absorbing polymer particles.

31. The method as claimed in claim 29 wherein the adhesive comprises one selected from the group consisting of: one-part epoxies; two-part epoxies; silicone adhesives; one-part acrylic adhesives; and two-part acrylic adhesives.

32. The method as claimed in claim 29, wherein the solid particles are selected from a group consisting of: sand; quartz; fly ashes; lignin; silica; glass; minerals; carbon; soil components; cement particles; inorganic construction materials; hydrophobic organic polymers; plate-shaped solid particles.

33. The method as claimed in claim 29 wherein the water-absorbing material is a polymer selected from the group consisting of: sodium polyacrylate; cross-linked polyacrylamide copolymers; ethylene maleic anhydride copolymers; cross-linked polyethyleneglycols; polyvinyl alcohol co-polymers; cross-linked carboxylmethylcellulose starch grafted copolymers of polyacrylonitrile; water-soluble epoxy resins; poly(ethylene-co-vinyl alcohol) (EVAL); poly(ethylene-co-vinyl acetate) (EVAc); and water soluble polyurethanes.
